(19) United States
(12) Patent Application Publication
(10) Pub. No.: US 2026/0177897 A1
(43) Pub. Date: Jun. 25, 2026

(54) PROJECTION DEVICE

(71) Applicant: Coretronic Corporation, Hsin-Chu (TW)

(72) Inventors: Wei-Min Chien, Hsin-Chu (TW); Yen-Ting Lin, Hsin-Chu (TW)

(73) Assignee: Coretronic Corporation, Hsin-Chu (TW)

(21) Appl. No.: 19/387,607

(22) Filed: Nov. 12, 2025

(30) Foreign Application Priority Data
Dec. 23, 2024 (CN) 202411901421.1

(51) Int. Cl. G03B 21/16; G03B 21/14; G03B 21/20

(52) U.S. Cl. CPC G03B 21/16; G03B 21/145; G03B 21/2033; G03B 21/208

(57) ABSTRACT

Disclosed is a projection device, including a light source module, an optical engine module and a lens module. The optical engine module includes a housing, a heatsink and a transmissive light valve, a light guide component and a light guide cover disposed inside the housing. The illumination beam provided by the light source module is transmitted in the light guide component and to the transmissive light valve. The light guide cover has a body and a heat dissipation opening. The body wraps the surrounding surface of the light guide component, while the heat dissipation opening exposes part of the surrounding surface of the light guide component. The heatsink includes a connecting part and a heatsink fin part. The first end of the connecting part is disposed in the heat dissipation opening of the light guide cover. The second end of the connecting part is connected to the heatsink fin part.

### CROSS-REFERENCE TO RELATED APPLICATION

This application claims the priority benefit of China application serial no. 202411901421.1, filed on Dec. 23, 2024. The entirety of the above-mentioned patent application is hereby incorporated by reference herein and made a part of this specification.

### BACKGROUND

### Field of the Disclosure

The present disclosure relates to an optical device, and particularly to a projection device.

### Description of Related Art

Generally speaking, single-panel LCD projectors utilize an open optical engine design, introducing external cool air to flow through the optical engine for cooling purposes. However, this method readily allows external dust to enter the optical engine, contaminating optical components, thereby leading to issues such as reduced reliability, shortened lifespan, and decreased projection quality. To avoid dust contamination, existing technology adopts an enclosed optical engine design, coupled with heatsinks penetrating the interior and exterior of the optical engine, allowing heat from inside the optical engine to be transferred to the outside via the heatsinks, and then exchanged through system fans. Compared to the open optical engine design, the enclosed optical engine design cannot directly remove thermal energy through convection, but must first conduct the thermal energy from the interior to the exterior of the optical engine, resulting in lower heat dissipation efficiency. To achieve the same heat dissipation effect, a larger volume is required. Furthermore, although the enclosed optical engine design improves the dust ingress issue, the airflow temperature cannot be maintained as low as the external environment like in the open optical engine design. Consequently, the brightness of the enclosed optical engine is not as high as that of the open optical engine, which limits the maximum brightness of the projector.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE DISCLOSURE

An embodiment of the present disclosure provides a projection device, including a light source module, an optical engine module, and a lens module. The light source module is configured to provide an illumination beam. The optical engine module includes a housing, a transmissive light valve, a light guide component, a light guide cover, and a heatsink. The housing is connected to the lens module, and the housing has a first opening. The transmissive light valve, the light guide component, and the light guide cover are configured within the housing. The transmissive light valve is located on the transmission path of the illumination beam, and configured to convert the illumination beam into an image beam. The light guide component is located between the transmissive light valve and the light source module. The light guide component has a light incident surface, a light output surface, and a surrounding surface connecting the light incident surface and the light output surface. The light incident surface is configured to receive the illumination beam. The illumination beam is transmitted within the light guide component and exits from the light output surface to be transmitted to the transmissive light valve. The light guide cover has a body and a heat dissipation opening. The body wraps the surrounding surface of the light guide component. The heat dissipation opening exposes a part of the surrounding surface. The heatsink includes a connecting part and a heatsink fin part. The first end of the connecting part is disposed in the heat dissipation opening of the light guide cover. The second end of the connecting part is connected to the heatsink fin part, and the heatsink fin part shields the first opening while being located outside the housing. The lens module is configured on the transmission path of the image beam, and configured to project the image beam out of the projection device.

Other objectives, features and advantages of the present disclosure will be further understood from the further technological features disclosed by the embodiments of the present disclosure, wherein there are shown and described preferred embodiments of this disclosure, simply by way of illustration of modes best suited to carry out the disclosure.

### BRIEF DESCRIPTION OF THE DRAWINGS

FIG. 1 is a three-dimensional view of a projection device according to an embodiment of the present disclosure.

FIG. 2 is a cross-sectional view taken along line I-I of FIG. 1.

FIG. 3 is a cross-sectional view taken along line II-II of FIG. 1.

FIG. 4 is a top view of the heat exchanger in FIG. 1.

FIG. 5 is a three-dimensional view of the projection device of FIG. 1 from another perspective.

FIG. 6 is a top view of FIG. 5.

### DESCRIPTION OF EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the drawings being described. The components of the present disclosure may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The present disclosure provides a projection device that may have good heat dissipation effect and image quality.

Other objectives and advantages of the present disclosure may be further understood from the technical features described in the disclosure.

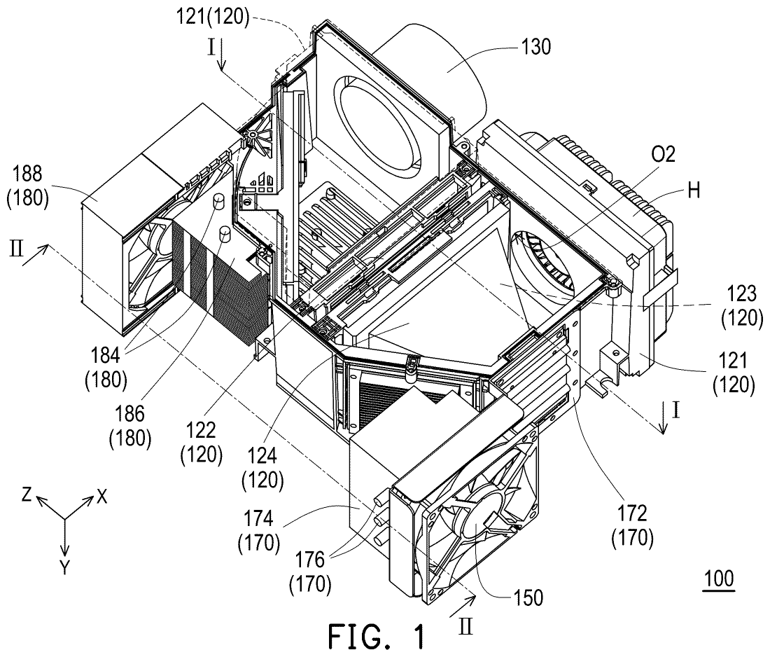

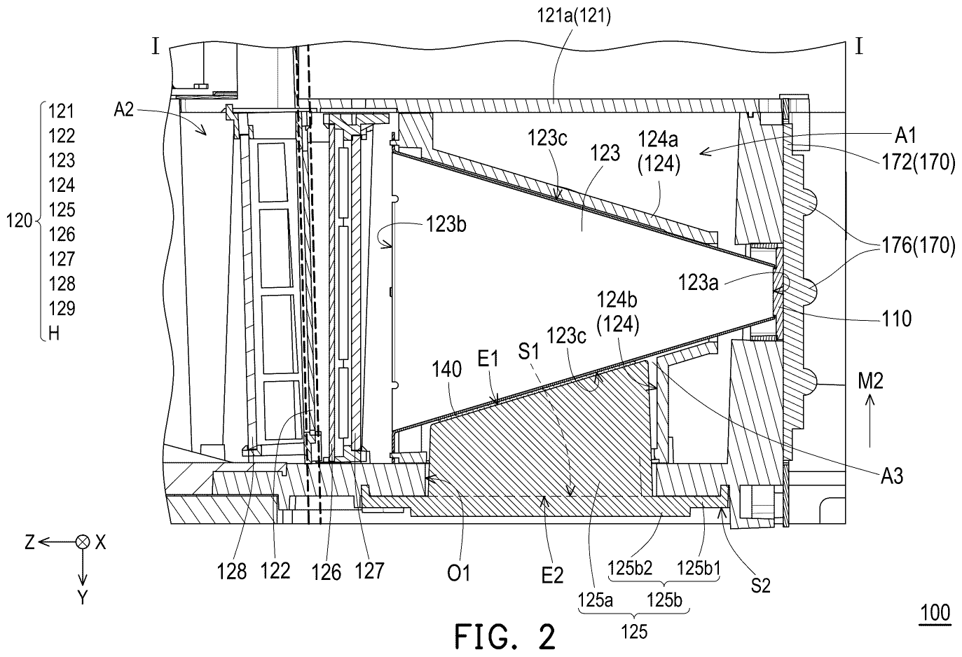

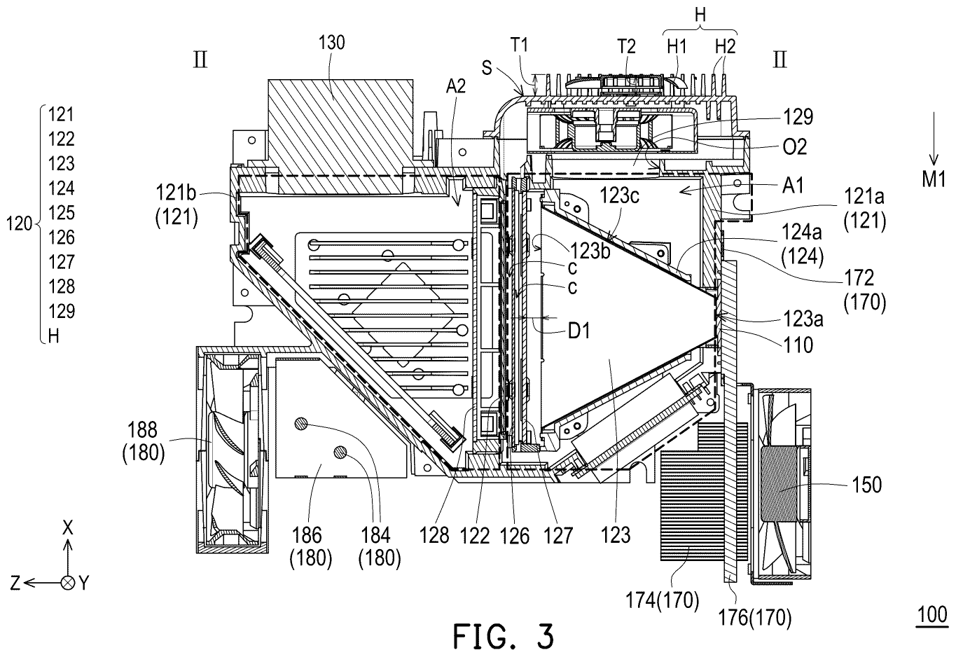

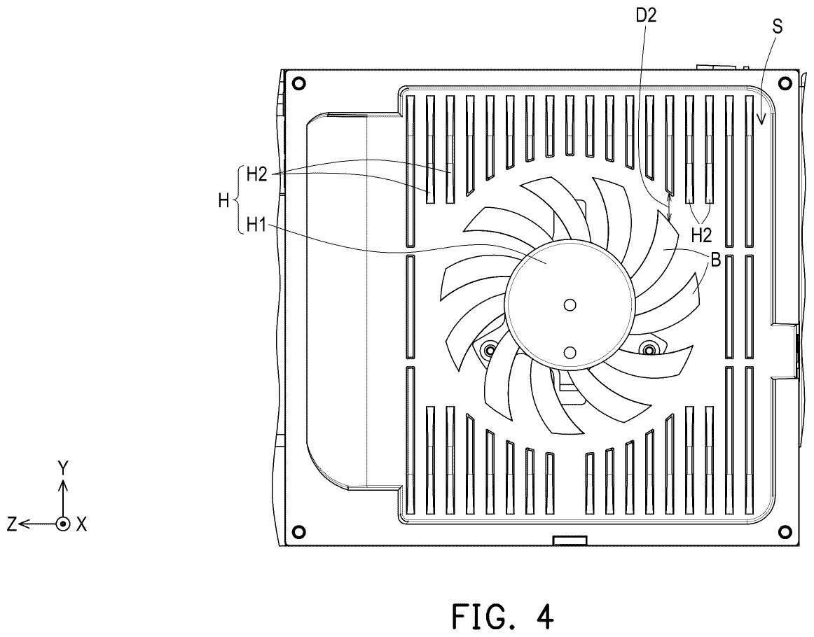

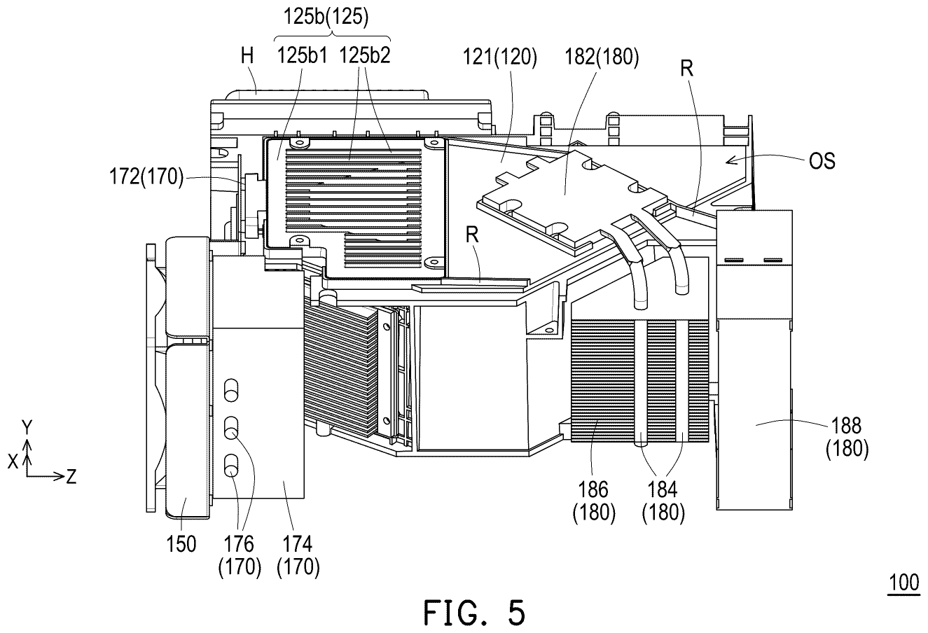

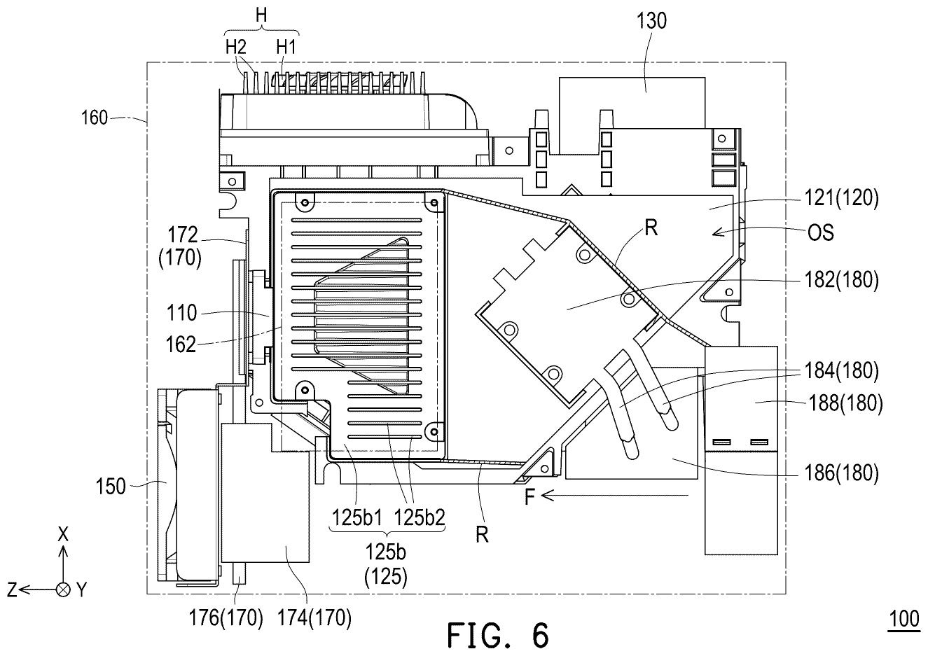

FIG. 1 is a three-dimensional view of a projection device according to an embodiment of the present disclosure. FIG. 2 is a cross-sectional view taken along line I-I of FIG. 1. FIG. 3 is a cross-sectional view taken along line II-II of FIG. 1. FIG. 4 is a top view of the heat exchanger in FIG. 1. FIG. 5 is a three-dimensional view of the projection device of FIG. 1 from another perspective. FIG. 6 is a top view of FIG. 5. For clarity of illustration, the system case is omitted from FIG. 1, and part of the housing of the optical engine module is illustrated with dashed lines. In FIG. 5, the system case is omitted, while in FIG. 6, the system case is illustrated with dashed lines.

Please refer to FIG. 1, FIG. 2 and FIG. 3 simultaneously. In this embodiment, the projection device 100 includes a light source module 110, an optical engine module 120, and a lens module 130. The light source module 110 is configured to provide an illumination beam. The optical engine module 120 is configured on the transmission path of the illumination beam, and configured to convert the illumination beam into an image beam. The lens module 130 is configured on the transmission path of the image beam, and configured to project the image beam out of the projection device 100.

In an embodiment, the light source module 110 may, for example, include one or more light-emitting devices, wherein the light-emitting devices may be one or more Laser Diodes (LD), one or more Light-Emitting Diodes (LED), or a combination of the above two light sources. Specifically, any light source that meets the volume requirements in actual design may be used for implementation, and the present disclosure is not limited in this regard. In an embodiment, the optical engine module 120 may include a transmissive light valve 122, such as a Transparent Liquid Crystal Panel, an Electro-Optical Modulator, a Magneto-Optic modulator, an Acousto-Optic Modulator (AOM), and so on. Detailed steps and implementation of the method by which the transmissive light valve 122 of the optical engine module 120 converts the illumination beam into an image beam may be sufficiently taught, suggested, and implemented through ordinary knowledge in the relevant technical field, so it will not be repeated here. The lens module 130, for example, includes a combination of one or more optical lenses with refractive power, such as various combinations of non-planar lenses including biconcave lenses, biconvex lenses, concavo-convex lenses, convexo-concave lenses, plano-convex lenses, and plano-concave lenses. In an embodiment, the lens module 130 may also include planar optical lenses to project the image beam from the transmissive light valve 122 out of the projection device 100 by reflection or transmission. Here, this embodiment does not limit the form and type of the lens module 130.

Specifically, in this embodiment, the optical engine module 120 includes a housing 121, a transmissive light valve 122, a light guide component 123, a light guide cover 124, and a heatsink 125. The housing 121 is connected to the lens module 130, and the housing 121 has a first opening O1. The transmissive light valve 122, the light guide component 123, and the light guide cover 124 are configured inside the housing 121. The transmissive light valve 122 is located on the transmission path of the illumination beam, and configured to convert the illumination beam into an image beam. The light guide component 123 is located between the transmissive light valve 122 and the light source module 110. The light guide component 123 has a light incident surface 123a, a light output surface 123b, and a surrounding surface 123c connecting the light incident surface 123a and the light output surface 123b. The light incident surface 123a is configured to receive the illumination beam. The illumination beam is transmitted within the light guide component 123 and emitted from the light output surface 123b to be transmitted to the transmissive light valve 122. In an embodiment, the light guide component 123 is, for example, a homogenizing rod. In an embodiment, the light guide component 123 may, for example, be a hollow light reflective cup.

Moreover, in this embodiment, the light guide cover 124 has a body 124a and a heat dissipation opening 124b. The body 124a of the light guide cover 124 wraps the surrounding surface 123c of the light guide component 123. The heat dissipation opening 124b of the light guide cover 124 exposes a part of the surrounding surface 123c of the light guide component 123. The heatsink 125 includes a connecting part 125a and a heatsink fin part 125b. A first end E1 of the connecting part 125a is disposed in the heat dissipation opening 124b of the light guide cover 124, while a second end E2 of the connecting part 125a is connected to the heatsink fin part 125b, and the heatsink fin part 125b shields the first opening O1 and is located outside the housing 121. Through this design, the thermal energy accumulated on the light guide component 123 inside the optical engine module 120 may be guided to the heatsink fin part 125b located outside the housing 121, therefore the projection device 100 of this embodiment may have a good heat dissipation effect, and thus may have good image quality. Since the first end E1 of the connecting part 125a of the heatsink 125 is disposed in the heat dissipation opening 124b of the light guide cover 124, it is possible to achieve a sealed and dust-proof heat dissipation effect. That is, the optical engine module 120 of this embodiment may be considered as an enclosed optical engine design, meaning the airflow inside and outside the optical engine module 120 is isolated from each other. In an embodiment, the connecting part 125a and the heatsink fin part 125b of the heatsink 125 are, for example, an integrally formed structure. In an embodiment, the material of the connecting part 125a and the heatsink fin part 125b of the heatsink 125 is, for example, metal, alloy, or material with good thermal conductivity, which allows the thermal energy on the light guide component 123 to be quickly guided to the outside of the housing 121.

Please refer to FIG. 2 again, the projection device 100 of this embodiment further includes a thermal interface material 140. The first end E1 of the connecting part 125a of the heatsink 125 is connected to part of the surrounding surface 123c of the light guide component 123 exposed by the heat dissipation opening 124b of the light guide cover 124 through the thermal interface material 140. Furthermore, the heatsink fin part 125b of the heatsink 125 includes an enclosed structure 125b1 and multiple fin structures 125b2. The enclosed structure 125b1 has a first surface S1 and a second surface S2 opposite to each other. The enclosed structure 125b1 is connected to the second end E2 of the connecting part 125a and the housing 121 through the first surface S1, and multiple fin structures 125b2 are disposed on the second surface S2 of the enclosed structure 125b. The fin structure 125b2 may be, for example, needle-shaped heatsink fins or plate-shaped heatsink fins, but the present disclosure is not limited thereto. In an embodiment, the orthographic projection of the first opening O1 of the housing 121 on the first surface S1 at least partially overlaps with the orthographic projection of the heat dissipation opening 124b of the light guide cover 124 on the first surface S1. In an embodiment, the orthographic projection area of the first end E1 of the connecting part 125a of the heatsink 125 on the first surface S1 is smaller than or equal to the orthographic projection area of the first opening O1 of the housing 121 on the first surface S1.

Please refer to FIG. 2 and FIG. 3 simultaneously. In this embodiment, the transmissive light valve 122 may divide the housing 121 into a first housing part 121a and a second housing part 121b. The first housing part 121a and the transmissive light valve 122 form a first accommodation space A1, while the second housing part 121b and the transmissive light valve 122 form a second accommodation space A2. In other words, with the transmissive light valve 122 as the boundary, the optical engine module 120 is divided into a front optical engine ranging from the light source module 110 to the transmissive light valve 122, and a rear optical engine ranging from the transmissive light valve 122 to the lens module 130. The first opening O1 of the housing 121 is located on the first housing part 121a. The light guide component 123, the light guide cover 124, and the connecting part 125a of the heatsink 125 are located in the first accommodation space A1, and one end part of the light guide cover 124 is connected to the first housing part 121a. The second housing part 121b is connected to the lens module 130.

Moreover, the optical engine module 120 further includes an optical film 126, a first converging lens 127, and a second converging lens 128. The optical film 126 is configured in the first accommodation space A1 and is located on the transmission path of the illumination beam from the light guide component 123 to the transmissive light valve 122. The first converging lens 127 is configured in the first accommodation space A1 and is located between the light guide component 123 and the optical film 126. The second converging lens 128 is configured in the second accommodation space A2, wherein the transmissive light valve 122 is located between the second converging lens 128 and the optical film 126. When the light source module 110 emits an illumination beam, the illumination beam is transmitted through the light guide component 123 by reflection to the first converging lens 127 to form parallel light. In an embodiment, the optical film 126 may be exemplified as a polarizing film, such as advanced polarization conversion film (APCF), but is not limited thereto. In an embodiment, if the illumination beam is non-polarized light, then this optical film 126 may polarize the illumination beam. In an embodiment, the first converging lens 127 and the second converging lens 128 are respectively Fresnel lenses, and configured to collimate the illumination beam and image beam into parallel light, respectively. In an embodiment, the second converging lens 128 is configured to converge the image beam emitted by the transmissive light valve 122 to match the size of the lens module 130. As shown in FIG. 3, there is a spacing D1 between the first converging lens 127 and the light output surface 123b of the light guide component 123, meaning they are arranged with an interval and not in direct contact, wherein the spacing D1 is, for example, from 2 millimeters to 10 millimeters, which may prevent the high temperature of the light guide component 123 from being conducted to the first converging lens 127. In an embodiment, the spacing D1 is, for example, 8 millimeters.

Moreover, the first housing part 121a of the housing 121 in this embodiment further has a second opening O2, and the optical engine module 120 further includes an optical engine fan 129, wherein the optical engine fan 129 is configured outside the first housing part 121a and shields the second opening O2. There are multiple airflow channels C between the first converging lens 127 and the optical film 126, as well as between the optical film 126 and the transmissive light valve 122. The airflow generated by the optical engine fan 129 during operation enters the first housing part 121a through the second opening O2 and flows through at least one of the multiple airflow channels C. In other words, the airflow channels C exist between the first converging lens 127 and the optical film 126, as well as between the optical film 126 and the transmissive light valve 122, and the airflow from the optical engine fan 129 may flow through at least one of these airflow channels C to dissipate heat in the first accommodation space A1.

In an embodiment, the second opening O2 may be considered as the air inlet of the optical engine fan 129. The airflow generated by the optical engine fan 129 flows through the second opening O2 and the airflow channels C into the first accommodation space A1. The channel between the second converging lens 128 located in the second accommodation space A2 and the transmissive light valve 122 may be provided with airflow by another fan (not shown), wherein the airflow in the first accommodation space A1 and the airflow in the second accommodation space A2 are not in communication with each other. In other words, the airflow entering the first accommodation space A1 does not flow into the second accommodation space A2, and the airflow entering the second accommodation space A2 does not flow into the first accommodation space A1, the airflows are isolated from each other. In short, the first accommodation space A1 and the second accommodation space A2 may be considered as independent sealed spaces.

Moreover, the light guide cover 124, the light guide component 123, and the connecting part 125a of the heatsink 125 define a third accommodation space A3. The third accommodation space A3 is located within the first accommodation space A1, wherein the airflow flowing through the first accommodation space A1 does not enter the third accommodation space A3. In other words, the third accommodation space A3 is also an independently sealed space. In an embodiment, the light guide cover 124 and the light guide component 123 are not tightly fitted together, but have a gap between them (i.e., there is air in the third accommodation space A3). In an embodiment, the material of the light guide cover 124 may be plastic, and there is air in the third accommodation space A3, wherein both plastic and air have low thermal conductivity coefficients, thus producing an insulating effect. In an embodiment, the thermal conductivity coefficient of the light guide cover 124 may be less than or equal to 0.2 W/m·K. That is to say, the thermal energy of the light guide component 123 is isolated from the first accommodation space A1 due to the wrapping of the light guide cover 124, and the thermal energy is concentrated and guided to the outside of the housing 121 through the heatsink 125.

Since the transmissive light valve 122 also generates thermal energy when being penetrated by the illumination beam, most of the thermal energy is concentrated in the front housing (i.e., in the first accommodation space A1) between the light source module 110 and the transmissive light valve 122. This embodiment uses the light guide cover 124, which is made of a material with low thermal conductivity coefficient and has an insulating effect, to form an isolated space (i.e., the third accommodation space A3) from the light guide component 123. This may reduce the high temperature of the light guide component 123 heating the front optical engine, while using the light guide cover 124 to fix the light guide component 123, thus preventing the light guide component 123 from directly contacting the first converging lens 127. This may avoid the high temperature of the light guide component 123 being conducted to the first converging lens 127, allowing the first converging lens 127 to maintain at a low temperature.

In brief, the projection device 100 of this disclosure uses the light guide cover 124 to isolate the light guide component 123 from the circulating airflow inside the optical engine, which may reduce the temperature of the internal circulating air. Moreover, the configuration of the light guide cover 124 may also fix the light guide component 123, preventing the light guide component 123 from directly contacting other optical components (such as the first converging lens 127), which may reduce the impact of the high temperature of the light guide component 123 on other optical components. Additionally, the light guide cover 124 has a heat dissipation opening 124b that exposes part of the surrounding surface 123c of the light guide component 123 and corresponds to the first opening O1 of the housing 121. The heatsink 125 contacts the light guide component 123 through the first opening O1 of the housing 121 and the heat dissipation opening 124b of the light guide cover 124. Under the circumstances, the heatsink 125 may simultaneously seal the first opening O1 of the housing 121, forming a sealed area (i.e., the first accommodation space A1 and the third accommodation space A3) for the front optical engine. Since the projection device 100 of this embodiment allows the interior of the optical engine to form the first accommodation space A1 and the second accommodation space A2 with the transmissive light valve 122 as the boundary, wherein the components with higher temperature inside the optical engine are all located in the first accommodation space A1, the first accommodation space A1 may be considered as a high-temperature region, thus effectively isolating the high-temperature region inside the optical engine from other components.

In addition, please refer to FIG. 1, FIG. 3 and FIG. 4 simultaneously. To further reduce the temperature inside the optical engine module 120 more effectively, the optical engine module 120 of this embodiment may further include a heat exchanger H. The heat exchanger H is disposed outside the first housing part 121a and covers the optical engine fan 129. In an embodiment, an orthographic projection area of the heat exchanger H on the second opening O2 is larger than an orthographic projection area of the optical engine fan 129 on the second opening O2. In this embodiment, the heat exchanger H includes a bracket fan H1 and multiple heatsink fins H2. The bracket fan H1 and multiple heatsink fins H2 are disposed on the surface S of the heat exchanger H away from the optical engine fan 129, with multiple heatsink fins H2 surrounding the bracket fan H1.

In an embodiment, the heatsink fins H2 may be needle-shaped heatsink fins or plate-shaped heatsink fins, but are not limited thereto. In an embodiment, the bracket fan H1 is specifically a frameless fan, which may enhance the heat dissipation effect of the optical engine module 120 without increasing the volume of the overall projection device 100. In an embodiment, there is a spacing D2 between multiple fan blades B of the bracket fan H1 and multiple heatsink fins H2, wherein the minimum distance of the spacing D2 may be greater than or equal to 2 millimeters. In an embodiment, the multiple heatsink fins H2 have a first height T1 relative to the surface S, while the bracket fan H1 has a second height T2 relative to the surface S, wherein the first height T1 is greater than the second height T2. In an embodiment, the heat exchanger H is located on the lateral surface of the housing 121, while the heatsink 125 is located at the bottom of the housing 121. Under the circumstances, the assembly direction M1 (e.g., parallel to the X-axis direction) of the heat exchanger H is perpendicular to the assembly direction M2 (e.g., parallel to the Y-axis direction) of the heatsink 125. In an embodiment, the heat exchanger H and the heatsink 125 are located at two opposite ends (i.e., lateral surface) of the first housing part 121a, respectively. Under the circumstances, the assembly direction M1 of the heat exchanger H may be parallel to the assembly direction M2 of the heatsink 125.

In addition, the projection device 100 further includes a system fan 150, configured outside the optical engine module 120, wherein the orthographic projection of the heatsink fin part 125b of the heatsink 125 in the direction parallel to the axis of the system fan 150 at least partially overlaps with the system fan 150. The airflow of the system fan 150 will flow through the heatsink fin part 125b of the heatsink 125, which may increase the heat dissipation effect. In an embodiment, the system fan 150 may be an axial fan, but is not limited thereto.

Next, please refer to FIG. 1, FIG. 5 and FIG. 6 simultaneously. In this embodiment, the outer surface OS of the housing 121 of the optical engine module 120 includes at least one protruding structure R (two protruding structures are illustratively shown), wherein the protruding structure R is configured to guide the airflow of the system fan 150 to the heatsink 125. Furthermore, the projection device 100 of this embodiment further includes a system case 160, having a system air inlet 162, wherein parts of the light source module 110, the optical engine module 120 and the lens module 130 are configured inside the system case 160, and the position of the heatsink fin part 125b of the heatsink 125 corresponds to the system air inlet 162.

Moreover, in order to have a good heat dissipation effect, the projection device 100 of this embodiment further includes a heat dissipation module 170, including a heat conductive substrate 172, a heat exchange device 174, and a heat conductor 176. The heat conductive substrate 172 is connected to the light source module 110 and the heat conductor 176. The heat conductor 176 passes through the heat exchange device 174, and the system fan 150 is configured on one side of the heat exchange device 174, and configured to generate airflow for cooling through the heat exchange device 174. In an embodiment, the heat exchange device 174 may be, for example, a heatsink fin, such as a needle-shaped heatsink fin or a plate-shaped heatsink fin, but is not limited thereto. In an embodiment, the heat conductor 176 is, for example, a heat pipe, but is not limited thereto.

In addition, the projection device 100 of this embodiment further includes a heat dissipation module 180 disposed outside the housing 121 of the optical engine module 120, which includes a heat conductive substrate 182, a heat conductor 184, a heat exchange device 186, and a system fan 188. The heat conductive substrate 182 is connected to the housing 121 and the heat conductor 184. The heat conductor 184 passes through the heat exchange device 186, and the system fan 188 is configured on one side of the heat exchange device 186, configured to generate airflow F for cooling through the heat exchange device 186. In an embodiment, the heat conductor 184 is, for example, a heat pipe. In an embodiment, the heat exchange device 186 may be, for example, a heatsink fin, such as a needle-shaped heatsink fin or a plate-shaped heatsink fin. In an embodiment, the system fan 188 is, for example, an axial fan, but is not limited thereto.

In summary, the embodiments of this disclosure at least have one of the following advantages or effects. In the design of the projection device of this disclosure, the optical engine module includes a housing, a transmissive light valve, a light guide component, a light guide cover, and a heatsink. The light guide cover has a body and a heat dissipation opening, wherein the body wraps around the surrounding surface of the light guide component, while the heat dissipation opening exposes a part of the surrounding surface. The heatsink includes a connecting part and a heatsink fin part, wherein the first end of the connecting part is disposed in the heat dissipation opening of the light guide cover, and the second end of the connecting part is connected to the heatsink fin part, and the heatsink fin part shields the first opening and is located outside the housing. Through this design, the thermal energy accumulated on the light guide component inside the optical engine module may be guided to the heatsink fin part located outside the housing. Therefore, the projection device of this disclosure may have a good heat dissipation effect, and thus may have good image quality.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A projection device, comprising: a light source module, an optical engine module, and a lens module; wherein
the light source module is configured to provide an illumination beam;
the optical engine module comprises a housing, a transmissive light valve, a light guide component, a light guide cover, and a heatsink; wherein
the housing is connected to the lens module, and the housing has a first opening, the transmissive light valve, the light guide component, and the light guide cover are configured within the housing;
the transmissive light valve is located on a transmission path of the illumination beam, and configured to convert the illumination beam into an image beam;
the light guide component is located between the transmissive light valve and the light source module, the light guide component has a light incident surface, a light output surface, and a surrounding surface connecting the light incident surface and the light output surface, the light incident surface is configured to receive the illumination beam, the illumination beam is transmitted within the light guide component and exits from the light output surface to be transmitted to the transmissive light valve;
the light guide cover has a body and a heat dissipation opening, the body wraps the surrounding surface of the light guide component, the heat dissipation opening exposes a part of the surrounding surface; and
the heatsink comprises a connecting part and a heatsink fin part, a first end of the connecting part is disposed in the heat dissipation opening of the light guide cover, a second end of the connecting part is connected to the heatsink fin part, and the heatsink fin part shields the first opening while being located outside the housing; and
the lens module is located on a transmission path of the image beam, and configured to project the image beam out of the projection device.

2. The projection device according to claim 1, wherein the transmissive light valve divides the housing into a first housing part and a second housing part, the first housing part and the transmissive light valve form a first accommodation space, while the second housing part and the transmissive light valve form a second accommodation space, the first opening is located on the first housing part, the light guide component, the light guide cover, and the connecting part of the heatsink are located in the first accommodation space, and one end part of the light guide cover is connected to the first housing part.

3. The projection device according to claim 2, wherein the optical engine module further comprises:
an optical film, configured in the first accommodation space and located on a transmission path of the illumination beam from the light guide component to the transmissive light valve;
a first converging lens, configured in the first accommodation space and located between the light guide component and the optical film; and
a second converging lens, configured in the second accommodation space, wherein the transmissive light valve is located between the second converging lens and the optical film.

4. The projection device according to claim 3, wherein there is a spacing between the first converging lens and the light output surface of the light guide component, and the spacing is from 2 millimeters to 10 millimeters.

5. The projection device according to claim 3, wherein the first housing part further has a second opening, and the optical engine module further comprises an optical engine fan, wherein the optical engine fan is configured outside the first housing part and shields the second opening, there are a plurality of airflow channels between the first converging lens and the optical film, as well as between the optical film and the transmissive light valve, an airflow generated by the optical engine fan during operation enters the first housing part through the second opening and flows through at least one of the plurality of airflow channels.

6. The projection device according to claim 5, wherein the optical engine module further comprises a heat exchanger, and the heat exchanger is disposed outside the first housing part and covers the optical engine fan.

7. The projection device according to claim 6, wherein an orthographic projection area of the heat exchanger on the second opening is larger than an orthographic projection area of the optical engine fan on the second opening.

8. The projection device according to claim 6, wherein the heat exchanger comprises a bracket fan and a plurality of heatsink fins, the bracket fan and the plurality of heatsink fins are disposed on a surface of the heat exchanger away from the optical engine fan, with the plurality of heatsink fins surrounding the bracket fan.

9. The projection device according to claim 8, wherein there is a spacing between a plurality of fan blades of the bracket fan and the plurality of heatsink fins, wherein a minimum distance of the spacing is greater than or equal to 2 millimeters.

10. The projection device according to claim 8, wherein the plurality of heatsink fins have a first height relative to the surface, while the bracket fan has a second height relative to the surface, wherein the first height is greater than the second height.

11. The projection device according to claim 6, wherein an assembly direction of the heat exchanger is perpendicular to an assembly direction of the heatsink.

12. The projection device according to claim 1, further comprising:
a thermal interface material, wherein the first end of the connecting part of the heatsink is connected to the part of the surrounding surface of the light guide component exposed by the heat dissipation opening of the light guide cover through the thermal interface material.

13. The projection device according to claim 1, wherein the heatsink fin part comprises an enclosed structure and a plurality of fin structures, the enclosed structure has a first surface and a second surface opposite to each other, the enclosed structure is connected to the second end of the connecting part and the housing through the first surface, and the plurality of fin structures are disposed on the second surface of the enclosed structure.

14. The projection device according to claim 13, wherein an orthographic projection of the first opening of the housing on the first surface at least partially overlaps with an orthographic projection of the heat dissipation opening of the light guide cover on the first surface.

15. The projection device according to claim 13, wherein an orthographic projection area of the first end of the connecting part of the heatsink on the first surface is smaller than or equal to an orthographic projection area of the first opening of the housing on the first surface.

16. The projection device according to claim 1, wherein the housing has a first accommodation space, the light guide cover, the light guide component, and the connecting part of the heatsink define a third accommodation space, the third accommodation space is located within the first accommodation space, wherein an airflow flowing through the first accommodation space does not enter the third accommodation space.

17. The projection device according to claim 1, further comprising:
a system fan, configured outside the optical engine module, wherein an orthographic projection of the heatsink fin part of the heatsink in a direction parallel to an axis of the system fan at least partially overlaps with the system fan.

18. The projection device according to claim 17, wherein an outer surface of the housing of the optical engine module comprises at least one protruding structure, wherein the at least one protruding structure is configured to guide an airflow of the system fan to the heatsink.

19. The projection device according to claim 1, further comprising:
a system case, having a system air inlet, wherein parts of the light source module, the optical engine module and the lens module are configured inside the system case, and a position of the heatsink fin part of the heatsink corresponds to the system air inlet.

20. The projection device according to claim 1, wherein a thermal conductivity coefficient of the light guide cover is less than or equal to 0.2 W/m·K.
